(19) United States
(12) Patent Application Publication
(10) Pub. No.: US 2026/0089516 A1
(43) Pub. Date: Mar. 26, 2026

(54) METHODS AND APPARATUSES OF QUALITY OF EXPERIENCE (QOE)

(71) Applicant: Nokia Technologies Oy, Espoo (FI)

(72) Inventors: Jing HE, Beijing (CN); Malathi PONNIAH, Bangalore (IN); Ugur Baran ELMALI, Munich (DE); Hakon HELMERS, Massy (FR); Malgorzata TOMALA, Wroclaw (PL); Guillaume DECARREAU, Munich (DE)

(21) Appl. No.: 19/107,464

(22) PCT Filed: Sep. 1, 2022
(86) PCT No.: PCT/CN2022/116585

§ 371 Date: Feb. 27, 2025

(51) Int. Cl. H04W 24/02; H04W 24/10

(52) U.S. Cl. CPC H04W 24/02; H04W 24/10

(57) ABSTRACT

Example embodiments of the present disclosure relate to methods and apparatuses of quality of experience (QoE). A first device receives, from a second device, a QoE configuration request, wherein the QoE configuration request indicates an action for at least one of the following: QoE measurement data, at least one QoE configuration maintained at the first vice, or QoE measurement collection. The first device performs the action indicated in the QoE configuration request. Through this solution, it is flexible to control QoE measurement behaviors related to buffered QoE measurement data, previous QoE configuration(s), and/or performing of QoE measurement

### FIELD

Various example embodiments of the present disclosure generally relate to the field of telecommunication and in particular, to methods, devices, apparatuses and computer readable storage medium of quality of experience (QoE).

### BACKGROUND

In order to manage the quality provided by communication networks, there is an increasing need for technology of managing and guaranteeing the quality of experience (QoE). For this purpose, QoE Measurement Collection is introduced to measure end user experience when using certain applications, so as to ensure the level of quality that the user can experience. Currently, QoE measurements for streaming services and for Multicast Broadcast Services (MBS) in an idle state and/or an inactive state are asked to be supported by the 3rd Generation Partnership Project (3GPP).

### SUMMARY

In a first aspect of the present disclosure, there is provided a first device. The first device comprises at least one processor; and at least one transceiver coupled to the at least one processor and configured to: receive, from a second device, a quality of experience, QoE, configuration request, wherein the QoE configuration request indicates an action for at least one of the following: QoE measurement data, at least one QoE configuration maintained at the first device, or QoE measurement collection. The at least one processor is configured to perform the action indicated in the QoE configuration request.

In a second aspect of the present disclosure, there is provided a second device. The second device is configured to determine an action to be performed by a first device for at least one of the following: QoE measurement data, at least one QoE configuration maintained at the first device, or QoE measurement collection; and at least one transceiver coupled to the at least one processor and configured to transmit, to the first device, a QoE configuration request indicating the action.

In a third aspect of the present disclosure, there is provided a method. The method comprises: receiving, at a first device and from a second device, a quality of experience, QoE, configuration request, wherein the QoE configuration request indicates an action for at least one of the following: QoE measurement data, at least one QoE configuration maintained at the first device, or QoE measurement collection; and performing, at the first device, the action indicated in the QoE configuration request.

In a fourth aspect of the present disclosure, there is provided a method. The method comprises: determining, at a second device, an action to be performed by a first device for at least one of the following: quality of experience, QoE, measurement data, at least one QoE configuration maintained at the first device, or QoE measurement collection; and transmitting, from the second device and to the first device, a QoE configuration request indicating the action.

In a fifth aspect of the present disclosure, there is provided a first apparatus. The first apparatus comprises: means for receiving, from a second apparatus, a quality of experience, QoE, configuration request, wherein the QoE configuration request indicates an action for at least one of the following: QoE measurement data, at least one QoE configuration maintained at the first apparatus, or QoE measurement collection; and means for performing the action indicated in the QoE configuration request.

In a sixth aspect of the present disclosure, there is provided a second apparatus. The second apparatus comprises: means for determining an action to be performed by a first apparatus for at least one of the following: quality of experience, QoE, measurement data, at least one QoE configuration maintained at the first apparatus, or QoE measurement collection; and means for transmitting, to the first apparatus, a QoE configuration request indicating the action.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

In a ninth aspect of the present disclosure, there is provided a computer program comprising instructions which, when executed by an apparatus, cause the apparatus to perform at least the method according to the third aspect.

In a tenth aspect of the present disclosure, there is provided a computer program comprising instructions which, when executed by an apparatus, cause the apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication system in which example embodiments of the present disclosure can be implemented;

FIG. 2 illustrates a signaling chart for communication according to some example embodiments of the present disclosure;

FIG. 3 illustrates a signaling chart for communication according to some further example embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or”includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and/or services the terminal device in a communication network. The network device may refer to at least one of a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment”and “UE”may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

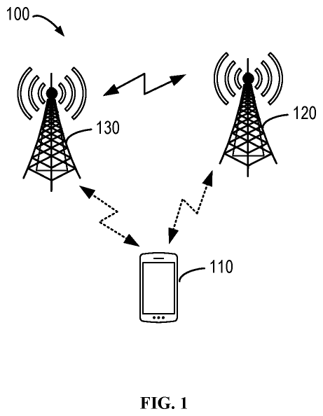

FIG. 1 illustrates an example communication system 100 in which example embodiments of the present disclosure can be implemented. The communication system 100 comprises a plurality of communication devices, including a first device 110 and a second device 120, can communicate with each other.

In the example of FIG. 1, the first device 110 may include a terminal device, and the second device 120 and the third device 130 may include network devices. A serving area of the second device 120 or the third device 130 may be called a cell.

Communications in the communication system 100 may be implemented according to any proper communication protocol(s), comprising, but not limited to, the third generation (3G), the fourth generation (4G), the fifth generation (5G), the sixth generation (6G), and beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connections shown in FIG. 1 are only for the purpose of illustration without suggesting any limitation. The communication system 100 may include any suitable number of devices configured to implementing example embodiments of the present disclosure. Although not shown, it would be appreciated that one or more additional devices may be located comprised in the communication system 100. It is noted that although being illustrated as a terminal device, the first device 110 may be other device than a terminal device. Although being illustrated as a network device, the second device 120 or the third device 130 may be other device than a network device.

In the following, for the purpose of illustration, some example embodiments are described with the first device 110 operating as a terminal device and the second device 120 and the third device 130 operating as network devices. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 and the third device 130 are network devices, a link from the second device 120 or the third device 130 to the first device 110 is referred to as a downlink (DL), while a link from the first device 110 to the second device 120 or the third device 130 is referred to as an uplink (UL). In DL, the second device 120 or the third device 130 is a transmitting (TX) device (or a transmitter) and the first device 110 is a receiving (RX) device (or a receiver). In UL, the first device 110 is a TX device (or a transmitter) and the second device 120 or the third device 130 is a RX device (or a receiver).

In the communication system 100, the first device 110 may change or switch between various operational states. In some cases, the first device 110 may be in a connected state with the second device 120 or the third device 130. In the connected state, the first device 110 may have at least one communication connection (e.g., a Radio Resource Control (RRC) connection) with the second device 120 or the third device 130, on which the first device 110 can actively communicate with the second device 120 or the third device 130, to transmit and/or receive data and control information. In the connected state, the second device 120 or the third device 130 to which the first device 110 is connected may have a context of the first device 110 (e.g., UE context). A device context (e.g., UE context) may comprise at least one of an access stratum context, one or more radio link configuration parameters, bearer configuration information, security information, layer configuration information, and/or other configuration information for the device.

In some cases, for the purpose of power saving, mobility, and others, the first device 110 may transit to a power saving state, such as an inactive state or an idle state. In the inactive state, the first device 110 not have an active communication connection (e.g., RRC connection). In some example embodiments, the context of the first device 110 may be maintained at the network side, such as at the second device 120 or the third device 130 to which the first device 110 was connected. In some example embodiments, the first device 110 in the inactive state may be able to perform for example small data transmission and/or control information exchange with the second device 120 or the third device 130. Bing in the inactive state allows the first device 110 to quickly resume the communication connection with the second device 120 or the third device 130. It is noted that the device to which the first device 110 is connected from the inactive state may be the same or different device to which the first device 110 was connected previously. In the idle state, the first device 110 has no communication connection (e.g., RRC connection) with a network device and no context maintained at the network side, such as the second device 120 or the third device 130.

At Radio Resource Control (RRC) layer of the first device 110, the connected state may be referred to as an RRC_Connected state, the inactive state may be referred to as an RRC_Inactive state, and the idle state may be referred to as an RRC_Idle state. The first device 110 may transit between the different operational states, for example, transit from a connected state to an inactive state or an idle state, from the inactive state to the connected state or the idle state, and/or from the idle state to the connected or inactive state.

In operation of a communication system, a first device such as a terminal device may be configured to perform Quality of Experience (QoE) measurement collection according to a QoE configuration, to collect QoE measurement data. The QoE measurement collection can be performed when the first device is in a connected state and the collected QoE measurement data may be reported to a device to which the first device is connected. Currently, with more services supported in the communication system, it is proposed that a device may also support the QoE measurement in other states, such in the inactive or idle state. For example, MBS (Multicast Broadcast Services), which allows for resource efficient transmission to multiple end users requesting to receive same contents, generally transmit information in DL and can support information communication even in the idle state or inactive state of the first device. The terminal device may perform real video (RV)-QoE measurement for the MBS service during the connected, idle, or inactive state.

However, new challenges are raised from the fact that QoE measurement collection is performed in the idle or inactive state. A first device can continue the QoE measurement collection but may not be able to report the collected QoE measurement data during the idle state or inactive state. One of the problems is that when the first device returns to a connected state, it cannot determine whether the collected QoE measurement data is still valid in a new cell, whether the new cell supports QoE measurement collection or configuration. In this case, the first device may not know how to handle the buffered QoE measurement data, previously configured QoE configuration(s), and/or whether or not to continue the QoE measurement collection. In some other cases, the first device may be configured to pause the QoE measurement data reporting or QoE measurement collection even if it is still in the connected state. Similar problem comes up when the first device can resume the QoE measurement data reporting or QoE measurement collection.

It has unexpected behaviors that the first device is potentially to remove the previous QoE configuration(s) and previous QoE measurement data when enters the idle or inactive state. In addition, this may lead to signaling overhead when the device to which the first device is connected would prefer to collect the previous QoE measurement data, and/or reuse the previous QoE configuration(s) for measurement collection.

According to some example embodiments of the present disclosure, there is provided a solution for QoE measurement control. In this solution, a first device is indicated by a second device an action for QoE measurement data, at least one QoE configuration maintained at the first device, and/or QoE measurement collection. The first device performs the action accordingly on the QoE measurement data, at least one QoE configuration maintained at the first device, and/or QoE measurement collection.

Through this solution, it is flexible to control QoE measurement behaviors related to buffered QoE measurement data, previous QoE configuration(s), and/or performing of QoE measurement collection, without leaving ambiguity to the first device. Further, by requesting the first device to properly handling the QoE measurement data, previous QoE configuration(s), and/or performing of QoE measurement collection, it can also save resource for reporting ineffective QoE measurement data, maintaining invalid QoE configuration(s), and/or performing meaningless QoE measurement collection.

Example embodiments of the present disclosure will be described in detail below with reference to the accompanying drawings.

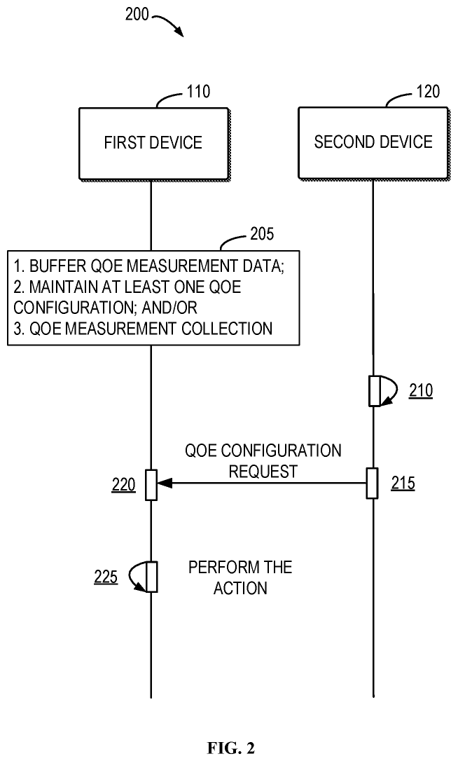

Reference is now made to FIG. 2, which shows a signaling chart 200 for communication according to some example embodiments of the present disclosure. As shown in FIG. 2, the signaling chart 200 involves a first device 110, a second device 120, and a third device 130. For the purpose of discussion, reference is made to FIG. 1 to describe the signaling chart 200.

In the signaling chart 200, the second device 120 determines 210 an action to be performed by the first device 110 for at least one of the following: QoE measurement data, at least one QoE configuration maintained at the first device 110, or QoE measurement collection. The second device 120 transmits 215, to the first device 110, a QoE configuration request which indicates the action to be performed.

In the signaling chart 200, it is assumed that the first device 110 may have QoE measurement data buffered and/or to be buffered. Alternatively, or in addition, the first device 110 may maintain at least one QoE configuration for QoE measurement collection. Alternatively, or in addition, the first device 110 may perform QoE measurement collection, to collect QoE measurement data. The buffering of QoE measurement data, maintaining of at least one QoE configuration, and/or QoE measurement collection are collectively illustrated in block 205.

Upon receipt 220 of the QoE configuration request from the second device 120, the first device performs 225 the action indicated in the QoE configuration request.

The first device 110 is configured to perform QoE measurement collection according to a QoE configuration(s), to collect QoE measurement data. The QoE measurement data may be buffered at the first device 110 and reported to a same or another communication device, for example, to a network device, when communication resources are available for the reporting. QoE measurement data comprises various QoE measurement metrics that are collectable by the first device 110. A QoE configuration, also referred to as a QoE measurement configuration, includes QoE measurement parameters, to configure QoE measurement at the first device 110. In some example embodiments, the QoE configuration may be transmitted to the first device 110 via a reconfiguration message, such as a RRC Reconfiguration message. The message may indicate a QoE measurement collection (QMC) configuration container, a configuration for reporting of QoE measurement data, such as a configuration for System Resource Block4 (SRB4), a service type for which the QoE measurement data is collected, and/or other information. In some example embodiments, the first device 110 may maintain multiple QoE configurations in parallel.

In some example embodiments, the first device 110 may receive a QoE configuration for QoE measurement collection for example at an Access Stratum (AS) layer, such as the RRC layer. The AS layer of the first device 110 may forward the QoE configuration and other needed parameters to for example an Application (App) layer of the first device 110. The QoE measurement collection may be performed at the App layer of the first device 110 and the collected QoE measurement data may be buffered for reporting.

It would be appreciated that some examples are provided above and there is not specific limitations to the QoE measurement data, the QoE configuration, and QoE measurement collection in embodiments of the present disclosure.

In example embodiments of the present disclosure, a configuration operation is provided for the second device 120 to configure the first device 110 on handling the previously buffered QoE measurement data, previous QoE configuration(s), and/or whether it needs to resume or stop the QoE measurement collection.

In some example embodiments, the first device 110 may transit from an idle state or an inactive state to a connected state with the second device 120. The first device 110 may perform the QoE measurement collection according to a QoE configuration(s) and buffer the collected QoE measurement data during the idle state or the inactive state. As an example embodiment, it is assumed that the first device 110 is in a connected state with the third device 130 in FIG. 1 and decides to transit to an idle or inactive state. The third device 130 may determine to select the first device 110 to continue QoE measurement collection in the idle or inactive state. The third device 130 then transmits an indication of continuing QoE measurement collection in the idle or inactive state, for example, in a message of putting the first device 110 into the idle or inactive state (e.g., a RRC Release message). Upon receipt of this indication, the first device 110 may performs QoE measurement collection when being in the idle or inactive state.

In this case, if the first device 110 connects to the second device 120 and transits from the idle or inactive state to connected state, the second device 120 may configure, through the QoE configuration request, the first device 110 on handling of the buffered QoE measurement data, previous QoE configuration(s), and/or QoE measurement collection. The QoE configuration request sent from the second device 120 may indicate the action to be performed in the case that the first device 110 transits from the idle or inactive state to a connected state. It is noted that the second device 120 may be a different device (e.g., a different network device) from a device to which the first device 110 was previously connected, or may be the same device.

In some example embodiments, the first device 110 may be in a connected state with the second device 120 when performing the QoE measurement collection according to a QoE configuration(s). The first device 110 may be configured to pause the QoE measurement reporting to the second device 120 and thus may need to buffer the collected QoE measurement data. In this case, the QoE configuration request sent from the second device 120 may indicate the action to be performed in the case that the first device 110 in the connected state is configured to recover reporting of the QoE measurement data.

In some example embodiments, in the QoE configuration request, the action for QoE measurement data may comprise discarding or retaining QoE measurement data buffered at the first device 110. In some example embodiments, the buffered QoE measurement data may be collected during a period of time when the first device 110 is in an idle or inactive state. In some example embodiments, the buffered QoE measurement data may be collected during a period of time when the first device 110 in a connected state pauses reporting of QoE measurement data. The second device 120 may flexibly configure whether or not to allow the first device 110 to continue reporting the QoE measurement data collected during the idle state or inactive state or during the period of paused reporting. For ineffective QoE measurement data, the second device 120 may command the first device 110 to discard it without reporting, which can save resources (e.g., in the air interface) used for communicating the measurement data and the buffering space at the first device 110.

In some example embodiments, in the QoE configuration request, the action for QoE configuration may comprise continuing or discarding the at least one QoE configuration maintained at the first device 110. The QoE configuration(s) maintained at the first device 110 may comprise a QoE configuration from one or more devices (e.g., a third device 130) to which the first device 110 was previously connected. The second device 120 may determine whether or not to reuse the QoE configuration(s) at a later stage for QoE measurement collection and then determine whether or not to configure the first device 110 to continue or discard the QoE configuration(s). For example, if the second device 120 is the same device to which the first device 110 was previously connected or is in a specific area scope within which a previous QoE configuration is still valid, there is no need to reconfigure the first device 110 with a new QoE configuration. The second device 120 may request the first device 110 to reuse (e.g., continue) a previous QoE configuration maintained at the first device 110, by transmitting an indication in the QoE configuration request. In some other examples, the second device 120 may request the first device 110 to discard the previous QoE configuration(s) for other reasons. In such a way, for invalid QoE configuration(s), the second device 120 may command the first device 110 to discard it directly or configure new one as replacement, without reporting, which can save signaling resources (e.g., in the air interface).

In some example embodiments, in the QoE configuration request, the action for QoE measurement collection may comprise resuming or stopping the QoE measurement collection. For example, if the first device 110 performs the QoE measurement collection when being in an idle or inactive state, and connects to the second device 120 from the idle or inactive state, the second device 120, which does not support QoE measurement collection, may request the first device 110 to stop the QoE measurement collection. In some cases, if the second device 120 does not support the QoE measurement collection due to temporal overload and may wish to resume the QoE measurement reporting later, it may indicate to the first device 110 to temporally stop (or suspend) or update the QoE measurement collection (to obtain up-to-date collection). In another example, if the first device 110 does not perform QoE measurement collection (for example, when being in an idle or inactive state, or when being requested to pause the collection QoE measurement collection), the second device 120 may request the first device 110 to resume the collection.

In some example embodiments, the action for the QoE measurement data, the at least one QoE configuration, and/or QoE measurement collection may be explicitly or implicitly indicated in the QoE configuration request. For the case of explicit indication, the QoE configuration request may include one or more fields for specific indications of the action for the QoE measurement data, the action for at least one QoE configuration, and/or the action for QoE measurement collection. For the case of implicit indication, in some example embodiments, an indication of continuing a QoE configuration may implicitly indicate an action of resuming the QoE measurement collection.

In some example embodiments, for the case of implicit indication, the QoE configuration request may contain information related to a further QoE configuration that is provided by the second device 120 to the first device 110. The action for the QoE measurement data, the at least one QoE configuration, and/or QoE measurement collection may be indicated by existence of the information related to the further QoE configuration in the QoE configuration request.

In some example embodiments, the QoE configuration request indicates providing a new QoE configuration (e.g., a QMC configuration container and SRB4 configuration) for the first device 110 to perform QoE measurement data, it may implicitly indicate that the new QoE configuration will override a previous QoE configuration(s) maintained at the first device 110. The first device 110 may either discard the previous QoE configuration(s) or stop using the previous QoE configuration(s) to collect QoE measurement data. The first device 110 may start QoE measurement collection with the new QoE configuration.

In some example embodiments, if the information contained in the QoE configuration request indicates no new QoE configuration is provided, it may implicitly indicate that the first device 110 may continue to use the previous QoE configuration(s) for QoE measurement collection.

In some example embodiments, the existence of a new QoE configuration may implicitly indicate discarding or retaining QoE measurement buffered at the first device 110, depending on a pre-agreement or pre-configuration between the first device 110 and the second device 120.

It would be appreciated that some examples for the implicit indications are provided above and there may be other ways to implicitly indicate the action in the QoE configuration request. It would also be appreciated in some other example embodiments, the QoE configuration request may contain information related to a further QoE configuration in addition to one or more explicit indications for the action.

In some example embodiments, the actions for the QoE measurement data, the actions for the at least one QoE configuration, and/or the actions for QoE measurement collection may be indicated the same or different signaling to the first device 110. In some example embodiments, the QoE configuration request may be transmitted from the second device 120 to the first device 110 in any suitable signaling.

In some example embodiments, the QoE configuration request may be transmitted in dedicated signaling to the first device 110.

Specifically, in some example embodiments, the QoE configuration request may be indicated in any of signaling transmitted to the first device 110 when the first device 110 connects to the second device 120 from the idle or inactive state. In some example embodiments, the QoE configuration request may be transmitted to the first device 110 when the first device 110 is in the idle or inactive state, during a state transition procedure, or after the first device 110 has completed the state transition.

As an example, the first device 110 in an inactive state may request to connect to the second device 120 via a RRC resume request. The second device 120 may accept the connection of the first device 110 and transmit a RRC resume message to the first device 110, which may include the QoE configuration request. In another example, if the first device 110 connects to the second device 120 from the idle state, the QoE configuration request may be included in a message transmitted to the first device 110 to indicate that a communication connection has been established. After the first device 110 has completed the state transition from the idle or inactive state, the QoE configuration request may be transmitted to the first device 110, for example, via a RRC reconfiguration message. In some examples, when the first device 110 is being in the inactive state, the QoE configuration request may be piggybacked in a message for small data transmission from the second device 120.

In some example embodiments, the QoE configuration request may be transmitted to the first device 110 when the first device 110 is in the connected state with the second device 120 (e.g., in the case of pausing the reporting of QoE measurement data, the second device 120 decides to recover the reporting). In this case, the QoE configuration request may be transmitted to the first device 110, for example, via a RRC reconfiguration message.

In some example embodiments, the QoE configuration request may be transmitted to the first device 110 via broadcast signaling, such as via System Information Block (SIB) signaling.

It would be apparated that the QoE configuration request may be transmitted to the first device 110 in any other suitable messages/signaling and the scope of the present disclosure is not limited in this regard.

In some example embodiments, the second device 120 may make a decision on the action for QoE measurement data, at least one QoE configuration, and/or the QoE measurement collection based on various factors and/or configuration information. As an example, in the case that the first device 110 connects to the second device 120 from an inactive state, the second device 120 may be able to retrieve context information from a device to which the first device 110 was previously connected (e.g., the third device 130) or the second device 120 may maintain the context information of the first device 110 locally. The context information may indicate a QoE configuration(s) used by the first device 110. By analyzing the QoE configuration(s) used by the first device 110, the second device 120 may decide whether or not to reuse the QoE configuration(s), whether or not to receive QoE measurement data collected according to the QoE configuration(s), and/or whether or not to allow the first device 110 to resume or stop QoE measurement collection according to the QoE configuration(s). In some example embodiments, the second device 120 may be configured via a core network element, such as Operation Administration and Maintenance (OAM) function, about whether or how to handle the QoE measurement data, at least one QoE configuration, and/or the QoE measurement collection.

It would be appreciated that the second device 120 may determine the action for QoE measurement data, at least one QoE configuration, and/or the QoE measurement collection based on any other factors and/or configuration information, which is not limited in the scope of the present disclosure.

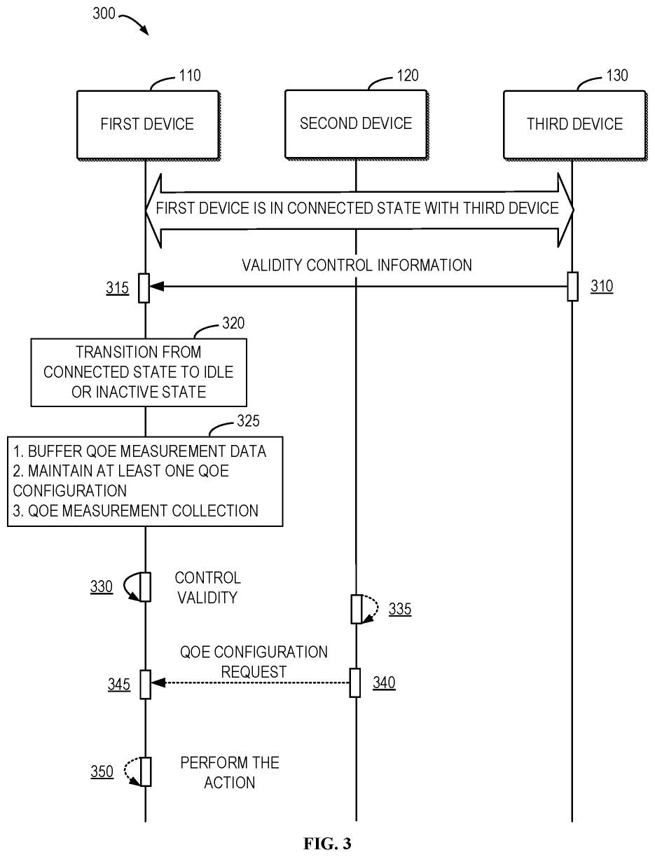

In some example embodiments, considering the QoE measurement collection performed when the first device 110 is in the inactive or idle state, in addition to the QoE configuration request, or as an alternative, the first device 110 may receive validity control information to control validity of the QoE measurement data, the QoE configuration(s), and/or the QoE measurement collection during the inactive or idle state. FIG. 3 shows a signaling chart 300 for communication according to such example embodiments. As shown in FIG. 3, the signaling chart 300 involves a first device 110, a second device 120, and a third device 130. For the purpose of discussion, reference is made to FIG. 1 to describe the signaling chart 300.

In the signaling chart 300, for the purpose of illustration, it is assumed that the first device 110 is first in a connected state with the third device 130. The third device 130 may transmit 310 and the first device 110 may receive 315 validity control information in an idle or inactive state of the first device 110 for at least one of the following: QoE measurement data, at least one QoE configuration maintained at the first device, or QoE measurement collection. The validity control information may be used to control validity of the QoE measurement data, at least one QoE configuration maintained at the first device 110, or QoE measurement collection, if the first device 110 transits to the idle state or the inactive state.

The validity control information may be conveyed to the first device 110 at any suitable time and any suitable signaling. In some example embodiments, the validity control information may be transmitted to the first device 110 in a message for putting the first device 110 into the inactive or idle state. For example, a RRC release message for instructing the first device 110 to switch from the connected state to the inactive state may include the validity control information. In some example embodiments, the validity control information may be comprised in any message transmitted to the first device 110 during the connected state, such as in a RRC reconfiguration message. The scope of the present disclosure has no limitation to the message used for conveying the validity control information.

In some example embodiments, the validity control information may indicate a valid time for buffered QoE measurement data during the idle or inactive state of the first device 110. Valid time may mean a time period for data collection/buffering up-to-date. In some example embodiments, the validity control information may indicate a valid time for the at least one QoE configuration maintained at the first device 110 during the idle state or the inactive state of the first device 110. Alternatively, or in addition, the validity control information may indicate a valid time for performing the QoE measurement collection during the idle or inactive state of the first device 110. Validity control information may indicate a valid buffer size to be used for QoE measurement data collection. By configuring the valid time, the third device 130 to which the first device 110 is connected can effectively control effectiveness of the QoE measurement data at the first device 110 during the inactive or idle state, and/or validity of the QoE configuration and/or QoE measurement collection during the inactive or idle state.

In some cases, the first device 110 may transit 320 from the connected state to the idle state or inactive state. When being in the idle state or inactive state, the first device 110 may still perform QoE measurement collection, to collect QoE measurement data according to one or more QoE configurations and buffer the collected QoE measurement data. The buffering of QoE measurement data, maintaining of at least one QoE configuration, and/or QoE measurement collection are collectively illustrated in block 325.

Without active communication connection, the collected QoE measurement data may be buffered at the first device 110. In some example embodiments, there may be QoE measurement data that are collected when the first device 110 is in the connected state but have no chance to be reported to the third device 130.

According to the validity control information received 310 from the third device 130, after transiting to the idle state or the inactive state, the first device 110 may control 330, based on the validity control information, validity of the at least one of the following: QoE measurement data, at least one QoE configuration maintained at the first device, or QoE measurement collection.

In some example embodiments, the first device 110 may start at least one timer with the at least one indicated valid time in the validity control information for buffered QoE measurement data, at least one QoE configuration maintained at the first device, and/or QoE measurement collection. In some example embodiments, if the valid time for the buffered QoE measurement data is expired, the first device 110 may discard the buffered QoE measurement data. If there is new QoE measurement data collected and/or buffered, the first device 110 may continue monitor the buffering time of those QoE measurement data and clean part of or all the measurement data collected and/or buffered from the buffer as long as the valid time is expired. In some example embodiments, if the valid time for a QoE configuration is expired, the first device 110 may stop the QoE measurement collection based on this QoE configuration, or may discard this QoE configuration. In some example embodiments, if the valid time for QoE measurement collection is expired, the first device 110 may stop the QoE measurement collection.

In some cases, the first device 110 may transit from the inactive or idle state to a connected state. In the example of FIG. 3, for the purpose of illustration, it is assumed that the first device 110 connects to the second device 120, although it would be appreciated that the first device 110 may connect to the third device 130 to which it was in the connected state previously.

The second device 120 determines 335 and transmits 340 a QoE configuration request indicating an action to be performed by the first device 110 for at least one of the following: QoE measurement data, at least one QoE configuration maintained at the first device 110, or QoE measurement collection. By receiving 345 the QoE configuration request, the first device 110 performs 350 the action in the QoE configuration request. The operations at 335, 340, 345 and 350 are similar to those operations at 210, 215, 220 and 225 in FIG. 2, which are omitted here for the purpose of brevity.

In some example embodiments, in the case of having the validity control information, the first device 110 may perform the action indicated in the QoE configuration request when the valid time indicated in the validity control information is expired, for example, when a valid time for the QoE measurement data, a valid time for the at least one QoE configuration maintained at the first device, and/or a valid time for the QoE measurement collection are expired.

In the example embodiments discussed above, through the QoE configuration request and/or the validity control information, the QoE measurement related behavior (for example, buffering of QoE measurement data, QoE configuration, and/or QoE measurement collection) in the inactive or idle state and/or in other cases may be flexibly and efficiently controlled according to actual requirements in different applications.

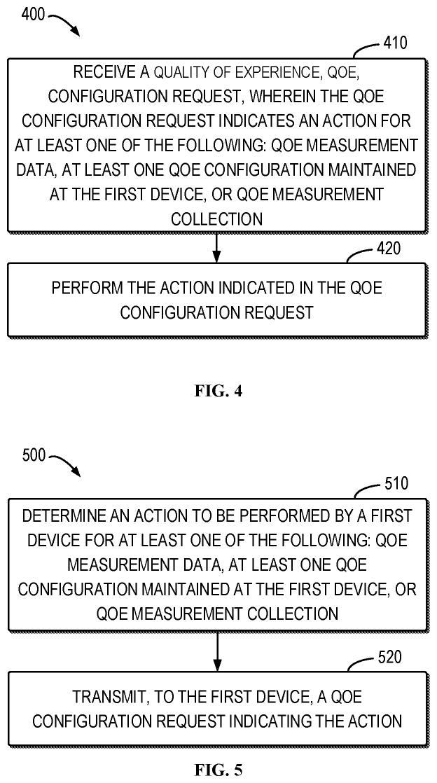

FIG. 4 shows a flowchart of an example method 400 implemented at a first device in accordance with some example embodiments of the present disclosure. For the purpose of discussion, the method 400 will be described from the perspective of the first device 110 in FIG. 1.

At block 410, the first device 110 receives, from a second device (e.g., the second device 120 in FIG. 1) a quality of experience, QoE, configuration request, wherein the QoE configuration request indicates an action for at least one of the following: QoE measurement data, at least one QoE configuration maintained at the first device, or QoE measurement collection.

At block 420, the first device 110 performs the action indicated in the QoE configuration request.

In some example embodiments, the action for QoE measurement data comprises discarding or retaining QoE measurement data buffered at the first device 110.

In some example embodiments, the action for QoE configuration comprises continuing or discarding the at least one QoE configuration maintained at the first device 110.

In some example embodiments, the action for QoE measurement collection comprises resuming or stopping the QoE measurement collection.

In some example embodiments, the QoE configuration request contains information related to a further QoE configuration, and wherein the action is indicated by existence of the information related to the further QoE configuration in the QoE configuration request.

In some example embodiments, the method 400 further comprises: receiving validity control information in an idle or inactive state of the first device 110 for at least one of the following: QoE measurement data, at least one QoE configuration maintained at the first device 110, or QoE measurement collection; and in accordance with a determination that the first device 110 transits from a connected state to the idle or inactive state, control, based on the validity control information, validity of the at least one of the following: QoE measurement data, at least one QoE configuration maintained at the first device 110, or QoE measurement collection.

In some example embodiments, the validity control information indicates at least one of: a valid time for buffered QoE measurement data, a valid time for the at least one QoE configuration maintained at the first device 110, or a valid time for performing the QoE measurement collection.

In some example embodiments, the validity control information is received from a third device to which the first device 110 is connected in the connected state.

In some example embodiments, the QoE measurement data is collected during a period of time when the first device 110 is in an idle or inactive state.

In some example embodiments, the QoE configuration request indicates the action to be performed in one of the following cases: the first device 110 transits from an idle or inactive state to a connected state, a valid time is expired for the at least one of the following: the QoE measurement data, the at least one QoE configuration maintained at the first device 110, or the QoE measurement collection when the first device 110 is in the idle or inactive state, or the first device 110 in a connected state is configured to recover reporting of QoE measurement data.

In some example embodiments, the first device 110 comprises a terminal device, and the second device 120 comprises a network device.

In some example embodiments, the QoE configuration request is comprised in dedicated signaling or in broadcast signaling.

FIG. 5 shows a flowchart of an example method 500 implemented at a second device in accordance with some example embodiments of the present disclosure. For the purpose of discussion, the method 500 will be described from the perspective of the second device 120 in FIG. 1.

At block 510, the second device 120 determines an action to be performed by a first device (e.g., the first device 110 in FIG. 1) for at least one of the following: QoE measurement data, at least one QoE configuration maintained at the first device, or QoE measurement collection.

At block 520, the second device 120 transmits, to the first device 110, a QoE configuration request indicating the action.

In some example embodiments, the action for QoE measurement data comprises discarding or retaining QoE measurement data buffered at the first device 110.

In some example embodiments, the action for QoE configuration comprises continuing or discarding the at least one QoE configuration maintained at the first device 110.

In some example embodiments, the action for QoE measurement collection comprises resuming or stopping the QoE measurement collection.

In some example embodiments, the QoE configuration request contains information related to a further QoE configuration, and wherein the action is indicated by existence of the information related to the further QoE configuration in the QoE configuration request.

In some example embodiments, the method 500 further comprises: transmitting, to the first device 110, validity control information in an idle or inactive state of the first device 110 for at least one of the following: QoE measurement data, at least one QoE configuration maintained at the first device 110, or QoE measurement collection.

In some example embodiments, the validity control information indicates at least one of: a valid time of buffered QoE measurement data, a valid time of the at least one QoE configuration maintained at the first device 110, or a valid time for performing the QoE measurement collection.

In some example embodiments, the QoE measurement data is collected during a period of time when the first device 110 is in an idle or inactive state.

In some example embodiments, the QoE configuration request indicates the action to be performed in one of the following cases: the first device 110 transits from an idle or inactive state to a connected state, a valid time is expired for the at least one of the following: the QoE measurement data, the at least one QoE configuration maintained at the first device 110, or the QoE measurement collection when the first device 110 is in the idle or inactive state, or the first device 110 in a connected state is configured to recover reporting of QoE measurement data.

In some example embodiments, the first device 110 comprises a terminal device, and the second device 120 comprises a network device.

In some example embodiments, the QoE configuration request is comprised in dedicated signaling or in broadcast signaling.

In some example embodiments, a first apparatus capable of performing any of the method 400 (for example, the first device 110 in FIG. 1) may comprise means for performing the respective operations of the method 400. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a second apparatus, a quality of experience, QoE, configuration request, wherein the QoE configuration request indicates an action for at least one of the following: QoE measurement data, at least one QoE configuration maintained at the first apparatus, or QoE measurement collection; and means for performing the action indicated in the QoE configuration request.

In some example embodiments, the action for QoE measurement data comprises discarding or retaining QoE measurement data buffered at the first apparatus.

In some example embodiments, the action for QoE configuration comprises continuing or discarding the at least one QoE configuration maintained at the first apparatus.

In some example embodiments, the action for QoE measurement collection comprises resuming or stopping the QoE measurement collection.

In some example embodiments, the QoE configuration request contains information related to a further QoE configuration, and the action is indicated by existence of the information related to the further QoE configuration in the QoE configuration request.

In some example embodiments, the first apparatus further comprises: means for receiving validity control information in an idle or inactive state of the first apparatus for at least one of the following: QoE measurement data, at least one QoE configuration maintained at the first apparatus, or QoE measurement collection; and means for, in accordance with a determination that the first apparatus transits from a connected state to the idle or inactive state, controlling, based on the validity control information, validity of the at least one of the following: QoE measurement data, at least one QoE configuration maintained at the first apparatus, or QoE measurement collection.

In some example embodiments, the validity control information indicates at least one of: a valid time for buffered QoE measurement data, a valid time for the at least one QoE configuration maintained at the first apparatus, or a valid time for performing the QoE measurement collection.

In some example embodiments, the validity control information is received from a third apparatus to which the first apparatus is connected in the connected state.

In some example embodiments, the QoE measurement data is collected during a period of time when the first apparatus is in an idle or inactive state.

In some example embodiments, the QoE configuration request indicates the action to be performed in one of the following cases: the first apparatus transits from an idle or inactive state to a connected state, a valid time is expired for the at least one of the following: the QoE measurement data, the at least one QoE configuration maintained at the first apparatus, or the QoE measurement collection when the first apparatus is in the idle or inactive state, or the first apparatus in a connected state is configured to recover reporting of QoE measurement data.

In some example embodiments, the first apparatus comprises a terminal device, and the second apparatus comprises a network device.

In some example embodiments, the QoE configuration request is comprised in dedicated signaling or in broadcast signaling.

In some example embodiments, the first apparatus further comprises means for performing other operations in some example embodiments of the method 400 or the first device 110. In some example embodiments, the means comprises at least one processor; and at least one memory storing instructions that, when executed by the at least one processor, cause the performance of the first apparatus.

In some example embodiments, a second apparatus capable of performing any of the method 500 (for example, the second device 120 in FIG. 1) may comprise means for performing the respective operations of the method 500. The means may be implemented in any suitable form. For example, the means may be implemented in a circuitry or software module. The second apparatus may be implemented as or included in the second device 120 in FIG. 1.

In some example embodiments, the second apparatus comprises means for determining an action to be performed by a first apparatus for at least one of the following: quality of experience, QoE, measurement data, at least one QoE configuration maintained at the first apparatus, or QoE measurement collection; and means for transmitting, to the first apparatus, a QoE configuration request indicating the action.

In some example embodiments, the action for QoE measurement data comprises discarding or retaining QoE measurement data buffered at the first apparatus.

In some example embodiments, the action for QoE configuration comprises continuing or discarding the at least one QoE configuration maintained at the first apparatus.

In some example embodiments, the action for QoE measurement collection comprises resuming or stopping the QoE measurement collection.

In some example embodiments, the QoE configuration request contains information related to a further QoE configuration, and wherein the action is indicated by existence of the information related to the further QoE configuration in the QoE configuration request.

In some example embodiments, the second apparatus further comprises: means for transmitting, to the first apparatus, validity control information in an idle or inactive state of the first apparatus for at least one of the following: QoE measurement data, at least one QoE configuration maintained at the first apparatus, or QoE measurement collection.

In some example embodiments, the validity control information indicates at least one of: a valid time of buffered QoE measurement data, a valid time of the at least one QoE configuration maintained at the first apparatus, or a valid time for performing the QoE measurement collection.

In some example embodiments, the QoE measurement data is collected during a period of time when the first apparatus is in an idle or inactive state.

In some example embodiments, the QoE configuration request indicates the action to be performed in one of the following cases: the first apparatus transits from an idle or inactive state to a connected state, a valid time is expired for the at least one of the following: the QoE measurement data, the at least one QoE configuration maintained at the first apparatus, or the QoE measurement collection when the first apparatus is in the idle or inactive state, or the first apparatus in a connected state is configured to recover reporting of QoE measurement data.

In some example embodiments, the first apparatus comprises a terminal device, and the second apparatus comprises a network device.

In some example embodiments, the QoE configuration request is comprised in dedicated signaling or in broadcast signaling.

In some example embodiments, the second apparatus further comprises means for performing other operations in some example embodiments of the method 500 or the second device 120. In some example embodiments, the means comprises at least one processor; and at least one memory storing instructions that, when executed by the at least one processor, cause the performance of the second apparatus.

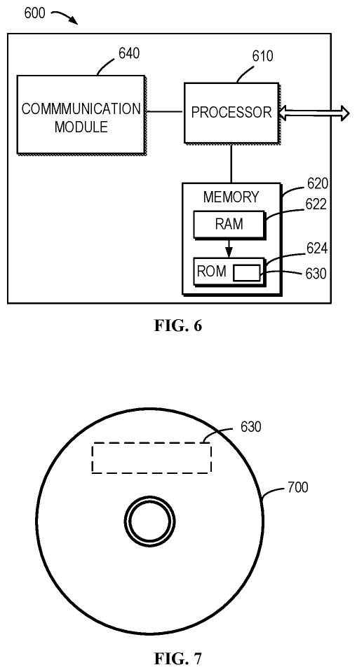

FIG. 6 is a simplified block diagram of a device 600 that is suitable for implementing example embodiments of the present disclosure. The device 600 may be provided to implement a communication device, for example, the first device 110, the second device 120, or the third device 130 as shown in FIG. 1. As shown, the device 600 includes one or more processors 610, one or more memories 620 that may couple to the processor 610, and one or more communication modules 640 that may couple to the processor 610.

The communication module 640 may be for bidirectional communications. The communication module 640 may have one or more communication interfaces to facilitate communication with one or more other modules or devices. The communication interfaces may represent any interface that is necessary for communication with other network elements. In some example embodiments, the communication module 640 may include at least one transceiver. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-28. (canceled)

29. A first device comprising:
at least one processor; and
at least one transceiver coupled to the at least one processor and configured to:
receive, from a second device, a quality of experience (QoE) configuration request, wherein the QoE configuration request indicates an action for at least one of the following: QoE measurement data, at least one QoE configuration maintained at the first device, or QoE measurement collection; and
wherein the at least one processor is configured to perform the action indicated in the QoE configuration request.

30. The first device according to claim 29, wherein the action for QoE measurement data comprises discarding or retaining QoE measurement data buffered at the first device.

31. The first device according to claim 29, wherein the action for QoE configuration comprises continuing or discarding the at least one QoE configuration maintained at the first device.

32. The first device according to claim 29, wherein the action for QoE measurement collection comprises resuming or stopping the QoE measurement collection.

33. The first device according to claim 29, wherein the QoE configuration request contains information related to a further QoE configuration, and wherein the action is indicated by existence of the information related to the further QoE configuration in the QoE configuration request.

34. The first device according to claim 29, wherein the at least one transceiver is further configured to receive validity control information in an idle or inactive state of the first device for at least one of the following: QoE measurement data, at least one QoE configuration maintained at the first device, or QoE measurement collection; and
wherein the at least one processor is configured to: in accordance with a determination that the first device transits from a connected state to the idle or inactive state, control, based on the validity control information, validity of the at least one of the following: QoE measurement data, at least one QoE configuration maintained at the first device, or QoE measurement collection.

35. The first device according to claim 34, wherein the validity control information indicates at least one of:
a valid time for buffered QoE measurement data, a valid time for the at least one QoE configuration maintained at the first device, or a valid time for performing the QoE measurement collection.

36. The first device according to claim 34, wherein the validity control information is received from a third device to which the first device is connected in the connected state.

37. The first device according to claim 29, wherein the QoE measurement data is collected during a period of time when the first device is in an idle or inactive state.

38. The first device according to claim 29, wherein the QoE configuration request indicates the action to be performed in one of the following cases:
the first device transits from an idle or inactive state to a connected state,
a valid time is expired for the at least one of the following: the QoE measurement data, the at least one QoE configuration maintained at the first device, or the QoE measurement collection when the first device is in the idle or inactive state, or
the first device in a connected state is configured to recover reporting of QoE measurement data.

39. The first device according to claim 29, wherein the first device comprises a terminal device, and the second device comprises a network device.

40. The first device according to claim 29, wherein the QoE configuration request is comprised in dedicated signaling or in broadcast signaling.

41. A second device comprising:
at least one processor configured to determine an action to be performed by a first device for at least one of the following: QoE measurement data, at least one QoE configuration maintained at the first device, or QoE measurement collection; and
at least one transceiver coupled to the at least one processor and configured to transmit, to the first device, a QoE configuration request indicating the action.

42. The second device according to claim 41, wherein the action for QoE measurement data comprises discarding or retaining QoE measurement data buffered at the first device.

43. The second device according to claim 41, wherein the action for QoE configuration comprises continuing or discarding the at least one QoE configuration maintained at the first device.

44. The second device according to claim 41, wherein the action for QoE measurement collection comprises resuming or stopping the QoE measurement collection.

45. The second device according to claim 41, wherein the QoE configuration request contains information related to a further QoE configuration, and wherein the action is indicated by existence of the information related to the further QoE configuration in the QoE configuration request.

46. The second device according to claim 41, wherein the at least one transceiver is further configured to:
transmit, to the first device, validity control information in an idle or inactive state of the first device for at least one of the following: QoE measurement data, at least one QoE configuration maintained at the first device, or QoE measurement collection.

47. The second device according to claim 41, wherein the QoE configuration request indicates the action to be performed in one of the following cases:
the first device transits from an idle or inactive state to a connected state,
a valid time is expired for the at least one of the following: the QoE measurement data, the at least one QoE configuration maintained at the first device, or the QoE measurement collection when the first device is in the idle or inactive state, or
the first device in a connected state is configured to recover reporting of QoE measurement data.

48. A method comprising:
receiving, at a first device and from a second device, a quality of experience, QoE, configuration request, wherein the QoE configuration request indicates an action for at least one of the following: QoE measurement data, at least one QoE configuration maintained at the first device, or QoE measurement collection; and
performing, at the first device, the action indicated in the QoE configuration request.
